(19) United States
(12) Patent Application Publication
(10) Pub. No.: US 2014/0327190 A1
(43) Pub. Date: Nov. 6, 2014

(54) VACUUM BAG MOLDING ASSEMBLY AND METHODS

(71) Applicant: GULFSTREAM AEROSPACE CORPORATION, Savannah, GA (US)

(72) Inventor: Paul J. Ballow, Savannah, GA (US)

(73) Assignee: Gulfstream Aerospace Corporation, Savannah, GA (US)

(21) Appl. No.: 13/875,982

(22) Filed: May 2, 2013

(51) Int. Cl. B29C 43/12; B29C 33/10

(52) U.S. Cl. CPC B29C 43/12; B29C 33/10
USPC 264/571; 425/388

(57) ABSTRACT

An assembly for vacuum bag molding includes a mold for receiving a workpiece. An edge breather comprising a plurality of braided polymer threads is disposed about a periphery of the workpiece. A vacuum bag film is disposed over the workpiece and the edge breather. A seal seals the vacuum bag film to the mold and a passageway in fluidic communication with the edge breather.

### TECHNICAL FIELD

The technical field generally relates to molding assemblies and methods, and more particularly relates to vacuum bag molding assemblies and methods for forming components by heat and pressure curing.

### BACKGROUND

Vacuum bag molding techniques are often used to create lightweight but very durable components, e.g., composite components made from layers of carbon fiber. In one typical process, layers of carbon fiber are disposed on a mold. Various breather elements are placed on and around the layers of carbon fiber. A vacuum bag film, e.g., nylon, is placed over the layers of carbon fiber and the breather elements to form an assembly. A vacuum is applied to evacuate air from an inside of the vacuum bag film. However, under normal atmospheric conditions not all of the air is removed from the layers of carbon fiber. To adequately remove this air, the assembly is cured at high temperatures and pressure, e.g., in an autoclave, while the vacuum is applied.

The pressure inside the vacuum bag film may be monitored with a pressure sensor. An abnormal positive pressure reading within the vacuum bag film may indicate a puncture in the vacuum bag film (which may be harmful to the structure of the component) or simply that some air is trapped in one of the breather elements (which is not typically harmful to the component). Because of the potential risk to the structure of the component, it is routine to subject a component to additional inspection and/or scrapping the component whenever a positive pressure reading is found.

As such, it is desirable to present assemblies and methods for preventing false positive pressure readings during the curing process. In addition, other desirable features and characteristics will become apparent from the subsequent summary and detailed description, and the appended claims, taken in conjunction with the accompanying drawings and this background.

### BRIEF SUMMARY

An assembly for vacuum bag molding is provided. In one embodiment, the assembly includes a mold for receiving a workpiece. An edge breather comprising a plurality of braided polymer threads is disposed about a periphery of the workpiece. A vacuum bag film is disposed over the workpiece and the edge breather. The assembly also includes a seal sealing the vacuum bag film to the mold and a passageway in fluidic communication with the edge breather.

A method of providing a molding assembly is also provided. In one embodiment, the method includes positioning a workpiece on a mold. The method also includes disposing an edge breather comprising a plurality of braided polymer threads about a periphery of the workpiece. A vacuum bag film is disposed over the workpiece and the edge breather. The method further includes sealing the vacuum bag film to the mold and providing a passageway in fluidic communication with the edge breather for evacuating air therethrough.

A method of forming a component is also provided. The method includes providing a molding assembly by positioning at least one layer of carbon fiber on a mold, disposing a release film above the at least one layer of carbon fiber, disposing an edge breather about a periphery of the at least one layer of carbon fiber, disposing a port defining a channel therethrough above the edge breather, disposing a vacuum bag film above the surface breather, the vacuum bag film having a hole aligned with the channel to provide a passageway to the edge breather, and sealing the vacuum bag film to the mold to encapsulate the plurality of layers of carbon fiber. The method also includes curing the molding assembly and applying a vacuum to the passageway during the curing.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a top view of a vacuum bag molding assembly according to an exemplary embodiment;

FIG. 2 is a partial cross-sectional side view of the assembly along the line 2-2 in FIG. 1 according to the exemplary embodiment;

FIG. 3 is a perspective view of a sleeve of braided polymer threads; and

FIG. 4 is a side view of an edge breather according to the exemplary embodiment comprising a first sleeve of braided polymer threads disposed within a second sleeve of braided polymer threads.

### DETAILED DESCRIPTION

Referring to the figures, wherein like numerals indicate like parts throughout the several views, a vacuum bag molding assembly 100 and associated methods are shown and described herein.

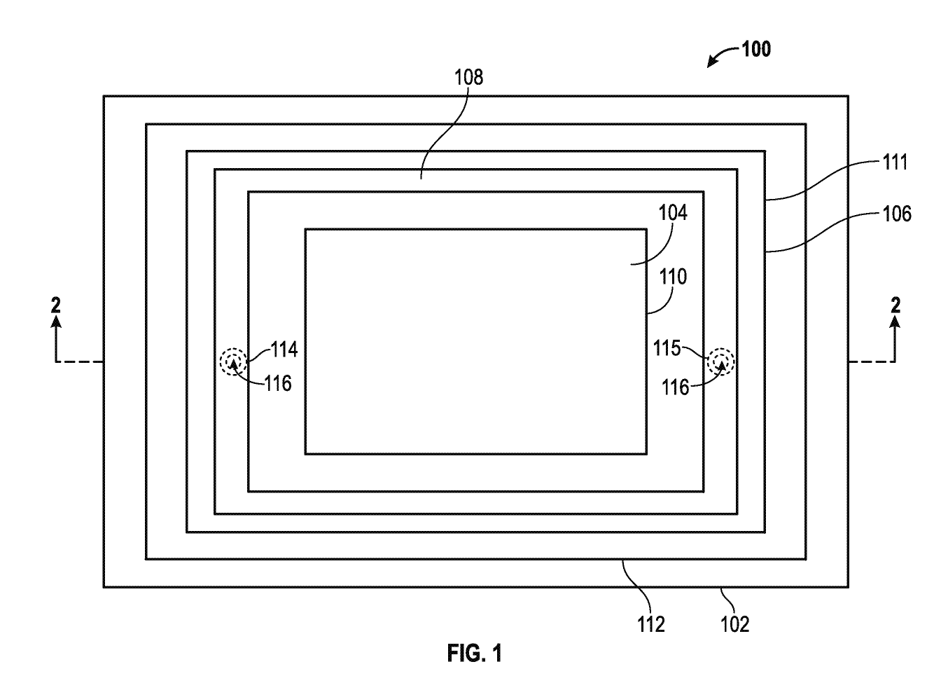

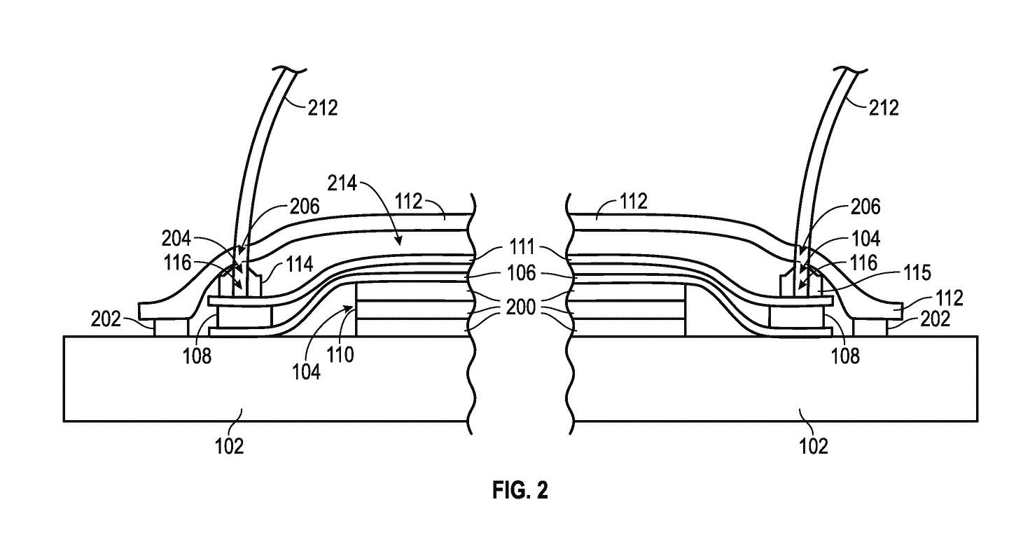

Referring to FIGS. 1 and 2, the assembly 100 includes a mold 102 for receiving a workpiece 104. The workpiece 104 in the illustrated embodiments includes a plurality of layers 200 of carbon fiber, laid atop one another, as can be seen in FIG. 2. However, other materials may be utilized in place of, or in addition to, the layers 200 of carbon fiber. Furthermore, while the mold 102 and workpiece 104 of the illustrated embodiments is substantially flat, those skilled in the art realize that the mold 102 and/or the workpiece 104 may be curved as required by the design of the workpiece 104.

In the illustrated embodiments, a release film 106 is disposed above the workpiece 104. The release film 106 allows the workpiece 104 to be easily separated from other components (described below) of the assembly 100, as is well appreciated by those skilled in the art.

The assembly 100 also includes an edge breather 108. The edge breather 108 is disposed about a periphery 110 of the workpiece 104. In the illustrated embodiments, the edge breather 108 is disposed entirely around the workpiece 104. That is, the edge breather 108 of the illustrated embodiment encloses the workpiece 104 to provide complete continuity therearound.

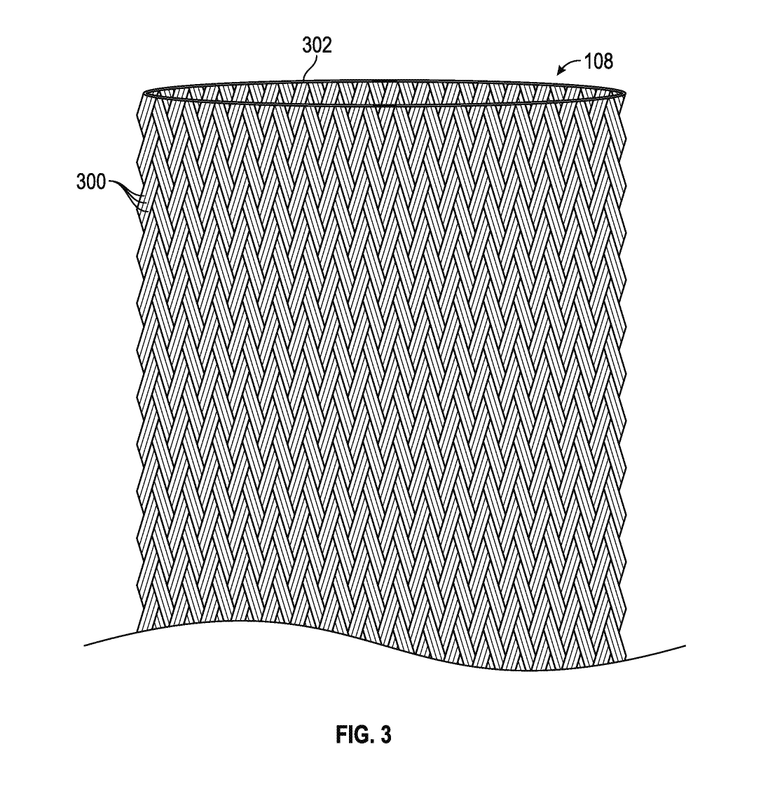

The edge breather 108 includes a plurality of polymer threads 300 braided together, as shown in FIG. 3. In the illustrated embodiments, the polymer threads 300 include polyethylene terephthalate (“PET”). More specifically, in the illustrated embodiments, groups of three PET threads 300, disposed side-to-side, are braided together with other groups of three PET threads 300. However, other configurations of braided polymer threads 300 may be utilized. The PET threads 300 of the illustrated embodiment have a diameter of about 10 mils, i.e., 10 thousandths of an inch or about 0.25 mm. However, other sizes of the polymer threads 300 may also or alternatively be utilized. Furthermore, other types of polymer threads 300 may be utilized. For example, the polymer threads 300 may include nylon instead of, or in addition to, PET.

The polymer threads 300 of the edge breather 108 may be braided into a sleeve 302. Said another way, the braided polymer threads 300 may have a generally tubular configuration. The sleeve 302 of the illustrated embodiments is flexible and may be pressed substantially flat. One suitable sleeve 302 is the Bentley-Harris® Expando® PT product manufactured by Federal Mogul Corporation of Southfield, Mich. However, other suitable sleeves 302 may also be utilized.

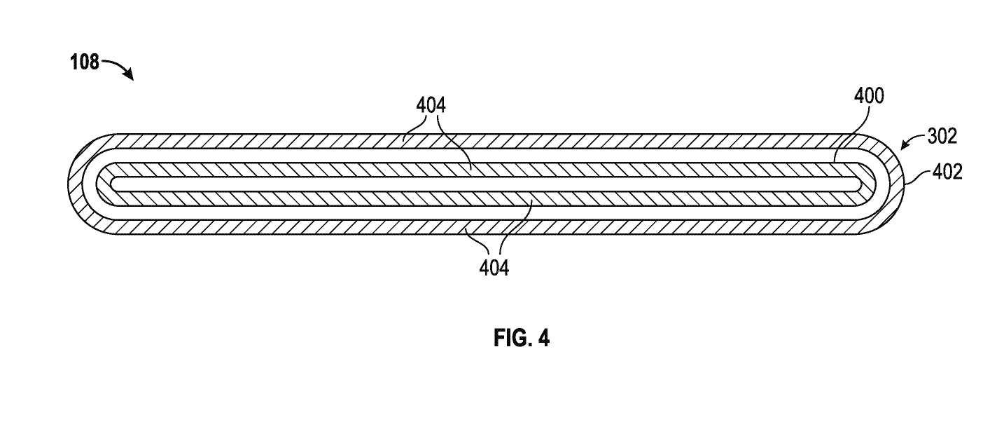

Referring now to FIG. 4, in one particular embodiment of the assembly 100, the edge breather 108 includes a plurality of sleeves 302 of braided polymer threads 300 (see FIG. 3): a first sleeve 400 and a second sleeve 402. In this embodiment, the first sleeve 400 is disposed inside the second sleeve 402. The sleeves 400, 402 are flexible and may be disposed in a substantially flat configuration. As such, four layers 404 of braided polymer threads 300 are produced. FIG. 4, which is a side view of the edge breather 108, omits detailed representations of the threads 300 to preserve viewability of the sleeves 400, 402.

Referring again to FIGS. 1 and 2, in the illustrated embodiments, the assembly 100 also includes a surface breather 111 disposed above the release film 106 and the edge breather 108. The surface breather 111 comprises polyester and/or nylon felt as is appreciated by those skilled in the art. The density of the surface breather 111 may be varied as is appreciated by those skilled in the art.

The assembly 100 further includes a vacuum bag film 112 disposed over the workpiece 104 and the edge breather 108. The vacuum bag film 112 of the illustrated embodiment is also disposed over the surface breather 111 and the release film 106. In the illustrated embodiments, the vacuum bag film 112 comprises nylon and has a thickness of about 0.002-0.005 mils. However, other thicknesses for the vacuum bag film 112 may be contemplated by those skilled in the art.

Referring again to FIG. 2, a seal 202 is utilized to seal the vacuum bag film 112 to the mold 102. In the illustrated embodiments, the seal 202 may be implemented with a sealing tape sandwiched between the vacuum bag film 112 and the mold 102. Other products and techniques to implement the seal 202 are also well known to those skilled in the art.

Referring again to FIGS. 1 and 2, the assembly 100 of the illustrated embodiments also includes a port 114, 115 defining a channel 116 therethrough. The port 114, 115 is disposed above the edge breather 108 and between the surface breather 111 and the vacuum bag film 112.

Referring again to FIG. 2, the assembly 100 also includes a passageway 204 in fluidic communication with the edge breather 108. In the illustrated embodiments, the passageway 204 includes a hole 206 defined by the vacuum bag film 112 along with the channel 116 of the port 114, 115. The port 114, 115 permits connection of a hose 212 or other such device to extend fluidic communication with the passageway 204. In other embodiments (not shown), the passageway 204 may be formed by other techniques. For example, the passageway 204 could be formed by a channel (not shown) extending through the mold 102.

The passageway 204 may be utilized to evacuate air therethrough, i.e., out of the vacuum bag film 112. That is, a vacuum may be applied to the passageway 204 to remove air from an inside 214 of the vacuum bag film 112. The vacuum may be produced by a pump (not shown) powered by a motor (not shown) and fluidically connected to the hose 212, and thus fluidically connected to the passageway 204.

The passageway 204 may also be utilized to detect, sense, or otherwise measure a pressure within the vacuum bag film 112, utilizing a pressure sensor as appreciated by those skilled in the art. The assembly 100 may include multiple passageways 204. For instance, in one embodiment, one passageway 204 is utilized to evacuate air from the vacuum bag film 112 while another passageway 204 is utilized to measure pressure on the inside 214 of the vacuum bag film 112. Of course, additional passageways 204 may further be utilized for applying the vacuum or measuring the pressure.

In the illustrated embodiments, a width of the edge breather 108 is larger than a width of the passageway 204 and a width of the port 114, 115. More specifically, in the illustrated embodiments, the width of the edge breather 108, in the substantially flat configuration shown in FIG. 4, is about 2.5 inches (63.5 mm). Of course, other dimensions for the edge breather 108 may be applied depending on the particular application.

A method of forming a component, such as a composite component, is also presented. An exemplary embodiment method (not shown) includes providing a molding assembly, such as the molding assembly 100 described above. However, other molding assemblies may alternatively be implemented in conjunction with the method.

In the exemplary embodiment, providing the molding assembly 100 includes positioning the workpiece 104 on the mold 102. The workpiece 104 of the exemplary embodiment includes at least one layer 200 of carbon fiber. Providing the molding assembly 100 also includes disposing a release film 106 above the at least one layer 200 of carbon fiber.

Providing the molding assembly 100 further includes disposing the edge breather 108 about the periphery 110 of the at least one layer 200 of carbon fiber. In this exemplary embodiment, the edge breather 108 comprises a first sleeve 400 of braided polymer threads 300 disposed within a second sleeve 402 of braided polymer threads 300. However, as stated above, the edge breather 108 may comprises other configurations of braided polymer threads 300.

Providing the molding assembly 100 in the method of the exemplary embodiment also includes disposing a surface breather 111 over the release film 106 and the at least one layer 200 of carbon fiber. A first port 114 and a second port 115, each defining a channel 116 therethrough, are then disposed above the surface breather 111 and the edge breather 108. A vacuum bag film 112 is disposed above the surface breather 111, the ports 114, 115, the release film 106, and the at least one layer 200 of carbon fiber. The vacuum bag film 112 defines two holes, each hole 206 aligned with the channel 116 of one of the ports 114, 115 to provide a passageway 204 through the vacuum bag film 112 to the edge breather 108. The vacuum bag film 112 is sealed to the mold 102 to encapsulate the plurality of layers 200 of carbon fiber on an inside of the vacuum bag film 112.

The exemplary method of forming the component includes curing the molding assembly 100. Specifically, in the exemplary embodiment, the molding assembly 100 is cured in an autoclave (not shown) at temperatures exceeding 200° F. (93° C.) and pressures exceeding 50 psi (345 kPa). More specifically, the molding assembly 100 of the exemplary embodiment is cured at temperatures around 360° F. and pressures about 130 psi (896 kPa). Of course, the curing temperatures and pressures may be varied depending on the particular requirements of forming the component, as appreciated by those skilled in the art.

The exemplary method of forming the component further includes applying a vacuum to the passageway 204 during the curing. Said another way, air is evacuated from the inside of the vacuum bag film 112 during the curing. The exemplary method may also include sensing a pressure inside the vacuum bag film 112 during the curing. In the exemplary embodiment, the vacuum applied to the passageway 204 is adjusted to maintain a pressure of 0.1 inches of Hg (3.4 kPa) as measured at the second port 115.

Use of the edge breather 108 comprising a plurality of braided polymer threads 300 has several advantages over prior art edge breather elements. First, the edge breathers described herein allows for a rapid removal of air from the inside of the assembly 100 at room temperature. Furthermore, the edge breathers described herein allow for expanding air from inside of the assembly 100 effectively less than 100 psi in an autoclave. The edge breathers described herein creates an open path for any leak inside the assembly 100. Furthermore, the edge breathers described herein are reusable; unlike many prior art edge breathers which are only able to be used effectively one time.

Lastly, the edge breathers described herein eliminate virtually all false positive pressure readings. That is, positive pressure readings will accurately indicate whether or not a leak is present, as the edge breathers do not trap air therein, which leads to false positive pressure readings.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. An assembly for vacuum bag molding comprising:
a mold for receiving a workpiece;
an edge breather comprising a plurality of braided polymer threads disposed about a periphery of the workpiece;
a vacuum bag film disposed over the workpiece and the edge breather;
a seal sealing the vacuum bag film to the mold; and
a passageway in fluidic communication with the edge breather.

2. An assembly as set forth in claim 1 wherein said edge breather comprises a plurality of layers of the plurality of braided polymer threads.

3. An assembly as set forth in claim 1 wherein said edge breather comprises a sleeve of the plurality of braided polymer threads.

4. An assembly as set forth in claim 1 wherein said edge breather comprises a first sleeve of the plurality of braided polymer threads disposed within a second sleeve of the plurality of braided polymer threads.

5. An assembly as set forth in claim 1 wherein said braided polymer threads include polyethylene terephthalate (“PET”).

6. An assembly as set forth in claim 1 wherein said braided polymer threads include nylon.

7. An assembly as set forth in claim 1 wherein a width of said edge breather is larger than a width of said passageway.

8. An assembly as set forth in claim 1 wherein said passageway includes a hole in said vacuum bag film.

9. An assembly as set forth in claim 8 further comprising a port defining a channel therethrough and wherein said passageway includes said channel.

10. An assembly as set forth in claim 1 wherein said passageway is further defined as a first passageway for evacuating air therethrough and a second passageway for measuring pressure.

11. A method of providing a molding assembly, comprising:
positioning a workpiece on a mold;
disposing an edge breather comprising a plurality of braided polymer threads about a periphery of the workpiece;
disposing a vacuum bag film over the workpiece and the edge breather;
sealing the vacuum bag film to the mold; and
providing a passageway in fluidic communication with the edge breather for evacuating air therethrough.

12. A method as set forth in claim 11 wherein disposing an edge breather is further defined as disposing an edge breather having a plurality of layers of a plurality of braided polymer threads about a periphery of the workpiece.

13. A method as set forth in claim 11 wherein disposing an edge breather is further defined as disposing an edge breather having a sleeve of braided polymer threads about a periphery of the workpiece.

14. A method as set forth in claim 11 wherein the edge breather comprises a first sleeve of braided polymer threads disposed within a second sleeve of braided polymer threads.

15. A method of forming a component, comprising:
providing a molding assembly by
positioning at least one layer of carbon fiber on a mold,
disposing a release film above the at least one layer of carbon fiber,
disposing an edge breather about a periphery of the at least one layer of carbon fiber,
disposing a port defining a channel therethrough above the edge breather,
disposing a vacuum bag film above the surface breather, the vacuum bag film having a hole aligned with the channel to provide a passageway to the edge breather, and
sealing the vacuum bag film to the mold to encapsulate the plurality of layers of carbon fiber;
curing the molding assembly; and
applying a vacuum to the passageway during the curing.

16. A method as set forth in claim 15 wherein disposing an edge breather is further defined as disposing an edge breather having a plurality of layers of a plurality of braided polymer threads about a periphery of the workpiece.

17. A method as set forth in claim 15 wherein disposing an edge breather is further defined as disposing an edge breather having a sleeve of braided polymer threads about a periphery of the workpiece.

18. A method as set forth in claim 15 wherein the edge breather comprises a first sleeve of braided polymer threads disposed within a second sleeve of braided polymer threads.

19. A method as set forth in claim 15 further comprising disposing a surface breather over the workpiece and under the vacuum bag film.

20. A method as set forth in claim 15 further comprising sensing a pressure inside the vacuum bag film during the curing.
